(19) United States
(12) Patent Application Publication
(10) Pub. No.: US 2020/0139464 A1
(43) Pub. Date: May 7, 2020

(54) Bridged Guide for Electrical Discharge Machining

(71) Applicant: Makino Inc., Mason, OH (US)

(72) Inventors: Jordan Marcincavage, Mason, OH (US); Christopher J. Bingaman, Mason, OH (US); William W. Grobe, Maineville, OH (US)

(73) Assignee: Makino Inc., Mason, OH (US)

(21) Appl. No.: 16/180,755

(22) Filed: Nov. 5, 2018

(51) Int. Cl. B23H 7/26

(52) U.S. Cl. CPC B23H 7/265

(57) ABSTRACT

An electrode guide for use in electrical discharge machining is described, along with methods for construction and use. A notch can be made in a portion of the guide to allow for greater maneuverability in situations of small clearances. An alternative embodiment uses a bridge offset to achieve greater maneuverability and range of motion.

### TECHNICAL FIELD

The present disclosure is directed to industrial machining tools and processes, and more particularly to guides for use in electrical discharge machining.

### BACKGROUND

Electric discharge machining (EDM) is an industrial process used for cutting and shaping metal parts. The cutting or etching mechanism is provided by electrical discharges or sparks. An EDM tool can provide electrical power to a tool-electrode and form an arc of electricity from the tool-electrode to a workpiece-electrode. A portion of each electrode is worn away. This process allows the workpiece to be cut or shaped. A dielectric fluid surrounds the cutting process, helping to reduce temperatures and flush away debris. The tool-electrode can be continually replenished during use. EDM is often useful in the machining of harder metals that can otherwise be challenging to machine.

### BRIEF SUMMARY

In one embodiment, an electrode guide for use with electrical discharge machining (EDM) is described. The guide can comprise a body portion, a tube, and an electrode path. The body portion comprises a first end of the body configured to couple to EDM tooling. The tube can extend from a second end of the body, the tube comprising a notch and a discharge surface distal to the body portion. The electrode path can extend throughout the body portion and the tube and be configured to receive an electrode wire.

In another embodiment, a further electrode guide is described. The guide can comprise a body portion, a first end of the body configured to couple to EDM tooling. The guide can further comprise a tube extending from a second end of the body, and a bridge attached to the tube and extending distal to the body portion. The guide can further comprise a discharge surface attached to the bridge and distal from the tube; and an electrode path extending throughout the body portion, tube, and discharge surface, the electrode path configured to receive an electrode wire.

Another embodiment under the present disclosure can comprise a method for manufacturing an electrode guide for use in electrical discharge machining (EDM). The method can comprise: providing a body portion, the body portion configured to be coupled at a first end to EDM tooling and providing a metal tube. A notch can be created along a portion of the metal tube with a grinding machine. The metal tube can then be pressed into the body. The tube can be inserted into the body portion such that the notch is distal to the first end. In some embodiments an adhesive can be applied to attach the metal tube to the body portion. The body portion and metal tube can comprise an electrode path configured to receive an EDM electrode.

### BRIEF DESCRIPTION OF THE DRAWINGS

For a more complete understanding of the present innovation, reference is now made to the following descriptions taken in conjunction with the accompanying drawings, in which:

FIGS. 1A-1C are diagrams of different views of a guide under the present disclosure;

FIG. 2 is a cut away view of a guide embodiment under the present disclosure;

FIG. 3 is a diagram of an electrical discharge machining tool under the present disclosure;

FIG. 4 is a diagram of an electrical discharge machining tool under the present disclosure;

FIG. 5 is a diagram of and electrical discharge machining tool under the present disclosure;

FIG. 6 is a diagram of another guide embodiment under the present disclosure;

FIG. 7 is a flow-chart diagram of a method embodiment under the present disclosure; and

FIG. 8 is a flow-chart diagram of a method embodiment under the present disclosure.

### DETAILED DESCRIPTION

One difficulty in EDM is the inability or challenge when cutting workpieces in situations with limited range of movement. Typically EDM tools find it difficult to make cuts in small spaces or when other portions of a workpiece block the guide from interpolating or moving. One solution under the present disclosure comprises a notched guide. A guide is the portion of an EDM tool that holds the tool-electrode, connects to an arm of the EDM tool, and is maneuvered by the EDM tool for the cutting of the workpiece. Some embodiments under the present disclosure comprise a guide comprising a notch of removed material, allowing for greater maneuverability.

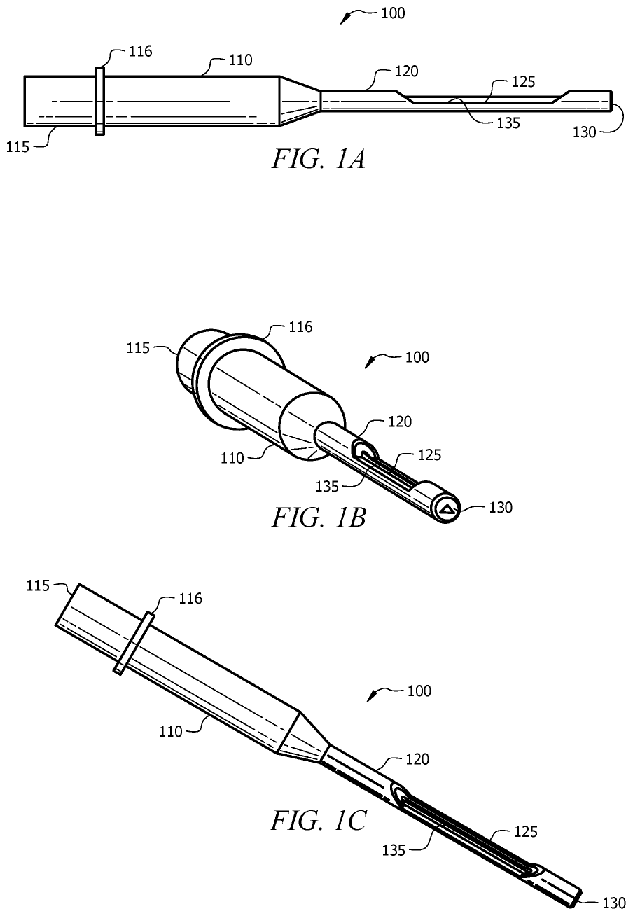

FIGS. 1A-1C show one embodiment under the present disclosure. Guide 100 comprises a locking portion 115, body 110, extension 120, and a notch 125. Groove or hole 135 extends through the guide and can hold a wire electrode. Locking portion 115 serves as a male portion that can connect to a female portion of an EDM tool and be locked in place. Distal to the locking portion 115 is a discharge surface 130. When an electrode wire is in place and the EDM tool is in use, the electrode wire can be made to spark from the exposed electrode at the discharge surface 130 and the spark will span to a portion of the workpiece—the workpiece electrode. The electrical spark/discharge erodes a small portion of both electrodes (workpiece and electrode wire) and, as this process continues, the workpiece can be cut or shaped. The notch 125 of guide 100 allows guide 100 to maneuver around nearby pieces of the workpiece or other items. Only a portion of the extension 120 has been removed to make the notch, but this can lead to greater maneuverability. Depending on the specific embodiment, the notch can be made larger or smaller as a user needs.

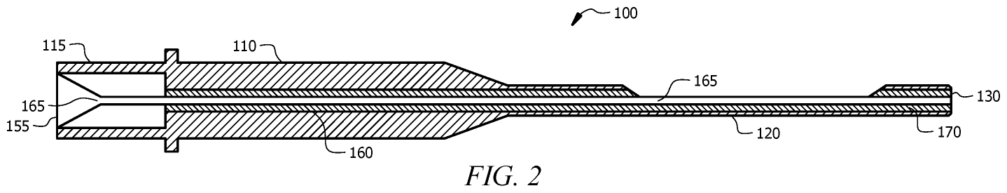

FIG. 2 displays a cut-away view of the guide 100 of FIGS. 1A-1C. As can be seen in this embodiment, extension 120 extends into body 110 and is pressed in place. Alternative embodiments can use glue or other adhesive or connection means. Any adhesive used should be non-conductive. A cap 155 (lead, in some embodiments) may be placed within the locking portion 115. A guide liner 170 is placed within the extension 120 at the discharge surface 130. Guide liner 170 may comprise silicon nitride but can comprise other ceramics or other substances depending on the embodiment. Guide liner 170 can comprise a non-conductive material. A bore or path 165 can extend all the way through the guide 100 and can receive an electrode wire. Body 110 and extension 120 may comprise any suitable material, such as stainless steel. Guide liner 170 can be non-conductive, such as ceramic, so that current used in the electrode can't ground or make electric contact back to steel of the EDM tooling. Guide 100 can comprise a ceramic along its entire bore or path 165 that may be touching an electrode wire, so as not to conduct electricity away from the electrode wire.

The notch 125 can take a variety of shapes, sizes and locations. Notch 125 may comprise large or small portions of extension 120. In certain embodiments notch 125 exposes the electrode, or electrode path 165 into which an electrode can be laid. In other embodiments the notch 125 can remove material of the guide but not expose the electrode wire. Embodiments may comprise notches sized to avoid features of different types, sizes, or layouts of different types of workpieces. Other examples of notch embodiments can include multiple notches, or notches that twist or shift their path along the length of extension 120.

Locking portion 115 can take the form required for attachment to a Makino™ EDBV machine, fast hole EDM, or other appropriate EDM tool. However, locking portion 115 can take other shapes or forms depending on the machine it will be used with. Ridge 116 can act as a barrier/border on the length of guide 100. Ridge 116 can be located so as to place notch 125 in a preferred location. Locking portion 115 can also comprise a bore, or flat face for orientation with a portion of an EDM tool so as to lock guide 100 in place rotationally. Various embodiments for coupling are possible. Locking portion 115 can comprise either part of a male/female couple, an interference fit, a sliding lock, or other coupling means.

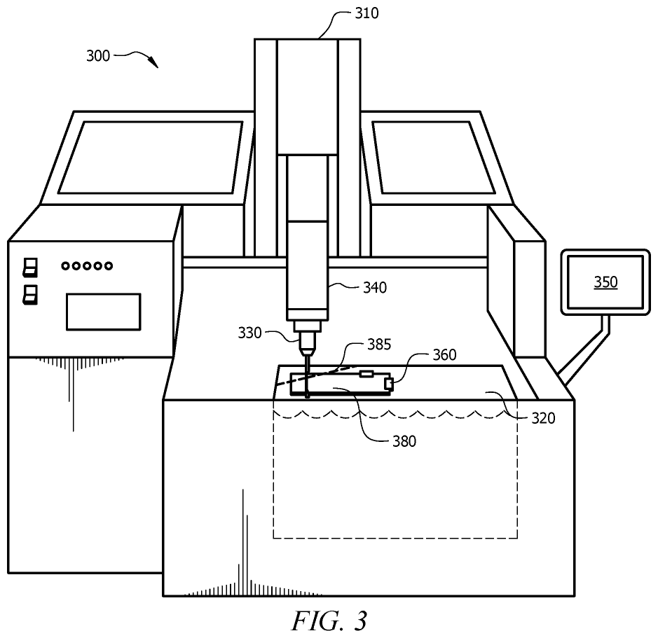

FIG. 3 shows a possible embodiment of EDM tool 300 that can utilize a guide embodiment such as guide 100 described in FIGS. 1 and 2. Tool 300 comprises a head unit 310, a holder 340, guide 330, dielectric reservoir 320, and an interface 350. Dielectric fluid can fill reservoir 320. Cutting can take place within the reservoir 320. Holder 340 can comprise a portion of head unit 310 and can couple to guide 330. In some embodiments, head unit 310 or holder 340 can move as a workpiece 380 is held in place in the dielectric reservoir 320. In other embodiments, the head unit 310 and holder 340 are stationary and the workpiece is moved by brackets 360, or other attachment mechanisms within the dielectric reservoir 320. Holder 340 may be able to move or rotate at various angles as necessitated by a desired cut. Either or both of holder 340 and brackets 360 may have some capabilities to move, rotate, or otherwise adjust for a proper cut. Interface 350 can comprise a touchscreen, computer screen and keyboard, or other means for a user to manage the tool 300. As tool 300 performs a cutting operation, dielectric fluid may be added to flush away waste such as metal chips.

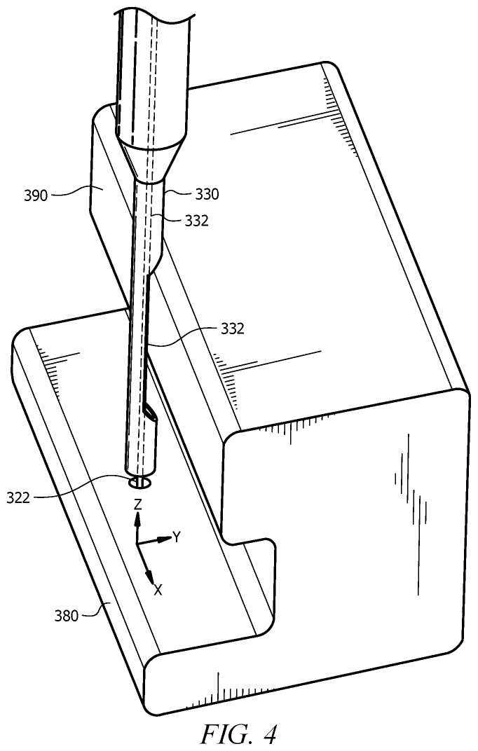

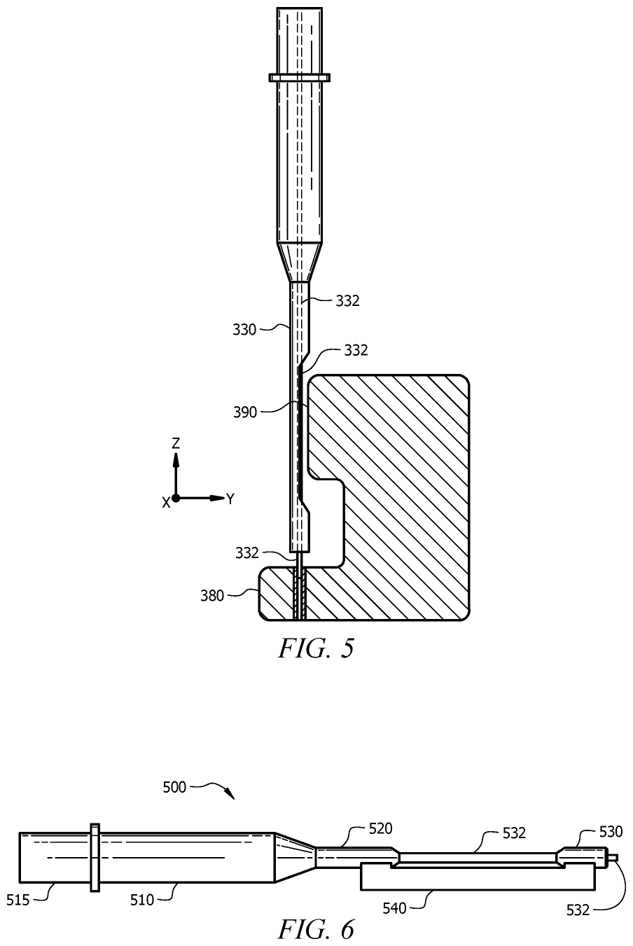

FIG. 4 displays an embodiment of tool 300 engaged in a cutting operation. Holder 340 can be coupled to guide 330. Electrode 332 extends through guide 330 and can be provided with voltage by tooling 300. When enough voltage is applied, a spark will jump between electrode 332 and a portion 322 of workpiece 380. Tool 300 can utilize electrode 332 to cut in the x, y, and z directions. How much material is removed can depend on the material, voltage, or other factors. Dielectric fluid 320 can surround the cutting operation, helping to absorb high temperatures and to wash away waste. As electrode 332 gets worn down, it can be replenished as tooling 300 pushes out further electrode material. Workpiece 380 can comprise an upper portion 390 that may impede on the motion of guide 330. The shape of guide 330, such as the cut away portion, allows the tool 300 to better complete the machining process. FIG. 5 shows another view of the embodiment of FIG. 4. FIG. 5 shows how electrode 332 can cut downward into workpiece 380. Guide 330 can therefore be used to cut holes or indentations, in addition to cutting in the x-y plane (horizontal in the perspective of FIG. 5).

Extension portion 120 of guide 100 (referencing FIGS. 1A-1C) can be given a notch or cut away portion by grinding. A stainless-steel tube, such as a hypodermic needle, or other metal tube, of any desired size, can be provided. A surface grinder can create the notch for various embodiments under the present disclosure. Other embodiments may include other means of cutting away or removing material so as to create the notch. In some embodiments the tube may be a guide taken from previously existing EDM tools or guides. The guide, with a newly added notch, can then be reattached to a locking portion or EDM tool. Such embodiments could be useful in “retrofit” situations.

A further possible embodiment of a guide under the present disclosure can be seen in FIG. 6. Guide 500 can comprise a locking portion 515, body 510, extension 520, discharge surface 530, electrode 532, and bridge 540. Bridge 540 can extend from one portion of the guide to another, and by being offset from the “tube”, the bridge 540 can allow greater maneuverability for the guide 500. In this embodiment, the use of the bridge 540 to connect extension 520 and discharge surface 530 can achieve some of the same space saving benefits of guide 100 of FIGS. 1A-1C. Because bridge 540 can be offset from extension 520 and electrode wire 532, the guide 500 may be able to make cuts that are otherwise impossible. In this embodiment, extension 540 and discharge surface 530 may comprise ceramics. Bridge 540 may comprise a metal, such as steel. Glue, adhesives, or other attachment means can be used to attach bridge 540 to the guide 500, such as at extension 520 and discharge surface 530. Bridge 540 can be offset from electrode wire 532 by any desired distance. Bridge 540 can be offset longitudinally from electrode wire 532 by any desired amount. Bridge can be thin or thick in any x, y, z direction, or even in an angular direction measured as an arc around guide 500. The bridge 540 can extend along extension 520 and discharge surface 530 any appropriate amount.

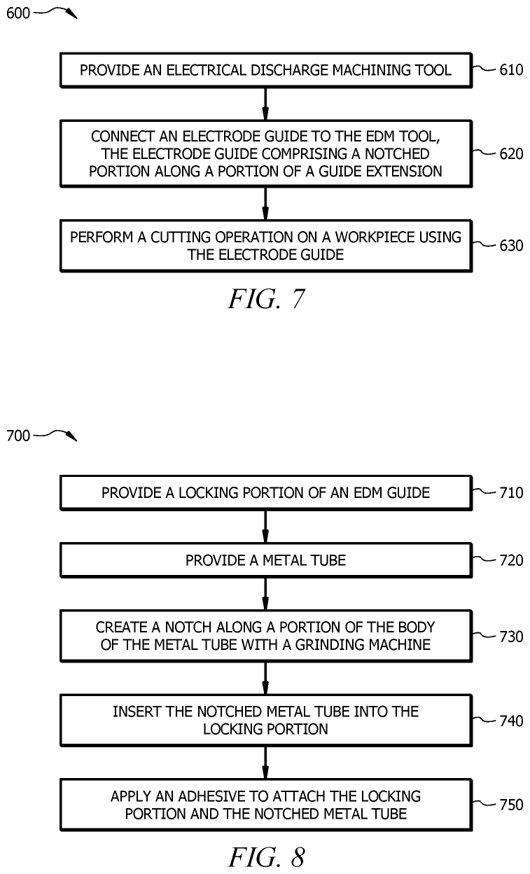

FIG. 7 displays one method embodiment 600 under the present disclosure. Method 600 comprises a method for carrying out a cutting operation with a notched or bridged guide such as described above. At 610, an electrical discharge machining tool is provided. At 620, an electrode guide is connected to the EDM tool, the electrode guide comprising a notched portion along a portion of a guide extension. At 630, a cutting operation is performed on a workpiece using the electrode guide.

FIG. 8 displays another embodiment 700 under the present disclosure. Method 700 comprises a method for constructing a notched guide as described herein. At 710, a locking portion of an EDM guide is provided. At 720, a metal tube is provided. At 730, a notch is created along a portion of the body of the metal tube with a grinding machine. At 740, the metal tube is inserted into the locking portion. At 750, an adhesive is applied to attach the locking portion and the notched metal tube. In addition, a ceramic lining may be applied to at least a portion of the interior of the metal tube, including possibly along the notched portion. In other method embodiments for constructing a notched guide, the elements of the guide can come from a previously made guide that lacks a notch. In such embodiments, similar to a “retrofit” situation, a notch can be added to an existing guide.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An electrode guide for use with electrical discharge machining (EDM), comprising:
a body portion, a first end of the body configured to couple to EDM tooling;
a tube extending from a second end of the body, the tube comprising a notch and a discharge surface distal to the body portion; and
an electrode path extending throughout the body portion and the tube configured to receive an electrode wire.

2. The electrode guide of claim 1 wherein the tube comprises stainless steel.

3. The electrode guide of claim 1 wherein the electrode path at least partially comprises a ceramic lining.

4. The electrode guide of claim 1 wherein the tube comprises a hypodermic needle.

5. The electrode guide of claim 1 wherein the notch exposes a portion of the electrode path.

6. The electrode guide of claim 1 wherein the tube is attached to an interior of the body portion by an adhesive.

7. The electrode guide of claim 1 wherein the body portion comprises a male portion configured to couple to a female portion of EDM tooling.

8. The electrode guide of claim 3 wherein the ceramic lining comprises silicon nitride.

9. An electrode guide for use with electrical discharge machining (EDM), comprising:
a body portion, a first end of the body configured to couple to EDM tooling;
a tube extending from a second end of the body;
a bridge attached to the tube and extending distal to the body portion;
a discharge surface attached to the bridge and distal from the tube; and
an electrode path extending throughout the body portion, tube, and discharge surface, the electrode path configured to receive an electrode wire.

10. The electrode guide of claim 9 wherein the tube comprises a ceramic.

11. The electrode guide of claim 9 wherein the electrode path is at least partially surrounded by a ceramic lining.

12. The electrode guide of claim 9 wherein the body portion comprises stainless steel.

13. The electrode guide of claim 9 wherein the bridge comprises stainless steel.

14. The electrode guide of claim 9 wherein the tube is attached to an interior of the body portion by an adhesive.

15. The electrode guide of claim 9 wherein the body portion comprises a male portion configured to couple to a female portion of EDM tooling.

16. The electrode guide of claim 11 wherein the ceramic lining comprises silicon nitride.

17. A method for manufacturing an electrode guide for use in electrical discharge machining (EDM), comprising:
providing a body portion, the body portion configured to be coupled at a first end to EDM tooling;
providing a metal tube;
creating a notch along a portion of the metal tube with a grinding machine; and
pressing the metal tube into the body portion such that the notch is distal to the first end;
wherein the body portion and metal tube comprise an electrode path configured to receive an EDM electrode.

18. The method of claim 17 further comprising attaching a ceramic liner to at least a portion of the electrode path.

19. The method of claim 17 wherein the metal tube comprises stainless steel.

20. The method of claim 18 wherein the ceramic liner comprises silicon nitride.
